(19) United States
(12) Patent Application Publication
(10) Pub. No.: US 2003/0114578 A1
(43) Pub. Date: Jun. 19, 2003

(54) Aqueous coating agents for baking enamels with a high solid content

(76) Inventors: Christian Wamprecht, Neuss (DE); Beate Baumbach, Leverkusen (DE); Heino Muller, Leverkusen (DE); Joachim Petzoldt, Monheim (DE)

Correspondence Address: BAYER CORPORATION, PATENT DEPARTMENT, 100 BAYER ROAD, PITTSBURGH, PA, 15205, US

(21) Appl. No.: 10/220,092

(22) PCT Filed: Feb. 15, 2001
(86) PCT No.: PCT/EP01/01649

(30) Foreign Application Priority Data
Feb. 28, 2000 (DE) 100 09 412.0
Feb. 28, 2000 (DE) 100 09 413.9
Feb. 28, 2000 (DE) 100 09 414.7

(51) Int. Cl. C08L 75/00; C08J 3/00

(52) U.S. Cl. 524/507; 525/124

(57) ABSTRACT

The invention relates to novel aqueous coating agents for baking enamels, in particular for producing hard, elastic fillers with a high solid content, for coating car bodies.

The present invention relates to novel aqueous coating compositions for stoving lacquerings, in particular for the production of hard, elastic, high-solids filler compositions for coating car bodies.

The importance of aqueous lacquers and coatings has risen sharply in recent years because of ever stricter emission guidelines in respect of the solvents released during application of the lacquer. Although aqueous lacquer systems have since already been available for many fields of use, these often cannot yet completely achieve the high quality level of conventional solvent-containing lacquers in respect of resistance to solvents and chemicals or also elasticity and resistance to mechanical stresses. In particular, no polyurethane-based coating compositions which are to be processed from the aqueous phase and completely meet the high requirements in practice of hard but at the same time elastic filler compositions of high solids content for coating car bodies in respect of film hardness, impact strength, resistance to flying stones and resistance to water and chemicals are as yet known.

This observation applies both to GB-A 1 444 933, EP-A 0 061 628 and DE-A 2 359 613, which are concerned with hydrophilic modification of aromatic polyisocyanates, and to DE-A 4 001 783, which is concerned with specific anionically modified aliphatic polyisocyanates, as well as to the systems of DE-A 2 DE-A 2 814 815, EP-A 0 012 348 and EP-A 0 424 697, which are concerned with aqueous stoving binders based on blocked polyisocyanates and organic polyhydroxy compounds. The systems based on polyurethane prepolymers which contain carboxyl groups and have masked isocyanate groups, according to DE-A 2 708 611, and the blocked water-soluble urethane prepolymers according to DE-A 3 234 590 are also largely unusable for the field of use mentioned. Significant advances in respect of elasticity and resistance to solvents, water and chemicals are to be achieved with the systems of DE-A 4 221 924, which describes combinations of specific blocked water-soluble or -dispersible polyisocyanate mixtures and specific water-soluble or -dispersible polyhydroxy compounds. Further improvements in respect of the required stoving temperature and reactivity of stoving lacquers can be achieved if water-dilutable or water-dispersible polyisocyanate crosslinking agents are used with pyrazoles as blocking agents, as described e.g. in WO 97/12924 and EP-A 0 802 210.

The solids content, including binders, crosslinking agents, additives, pigments and fillers, of these aqueous filler compositions described, some of which are in use in practice, is in general between 47 and 50, and a maximum of 53 wt. %, at the processing viscosity. However, a substantially higher solids content is desirable in this connection, in order to significantly improve the application efficiency during use. A substantially higher hardness is furthermore required for a better sandability of the filler compositions, where good elasticity properties should simultaneously guarantee a high level of protection against flying stones.

As has now been found, surprisingly, the preparation of stoving filler compositions which are to be processed from the aqueous phase and, in addition to the requirements met by the filler compositions in practice to date, have a higher solids content and give, after stoving, coatings of very high hardness but at the same time very good protection properties against flying stones is possible if selected combinations of the type described below in more detail are used as binders. The stoving lacquers according to the invention comprise:

I) specific binders dispersed in water,

II) water-soluble or -dispersible polyhydroxy compounds,

III) water-soluble or -dispersible crosslinking resins and

IV) optionally further water-soluble or -dispersible substances.

By using these new binder mixtures according to the invention in aqueous stoving lacquers, very high solids contents can be achieved. There is therefore an increase in the application efficiency and the yield. For filler composition applications, coatings in which the hardness and therefore also the sandability as well as the top lacquer status are improved compared with the prior art are obtained.

The invention provides binder mixtures for aqueous stoving lacquers, comprising:

I) specific binders dispersed in water,

II) water-soluble or -dispersible polyhydroxy compounds,

III) water-soluble or -dispersible crosslinking resins and

IV) optionally further water-soluble or -dispersible substances,

characterized in that component I) comprises:

A) at least one polyol component based on polyacrylate polyols and/or polyester-polyacrylate polyols with a hydroxyl group content of 1.0 to 8.0 wt. %, a carboxyl group content of 0 to 3 wt. %, a weight-average molecular weight of 2,000 to 50,000 and a glass transition temperature of >10° C.,

B) at least one polyisocyanate component with blocked isocyanate groups based on (cyclo)aliphatic polyisocyanates with a content of blocked isocyanate groups of 5.0 to 25.0 wt. %,

C) optionally further polyfunctional polyols,

D) optionally further crosslinking substances,

E) optionally external emulsifiers and

F) optionally conventional additives,

with the proviso that component I) has been prepared either by a direct dispersing process or by the phase inversion process by means of a dispersing device with a high dispersing output per unit volume and has an average particle size of the dispersion particles of 0.05 to 10 μm, preferably 0.1 to 5 μm, in particular at a particle diameter of 0.15 to 2.5 μm, and particularly preferably 0.2 to 1.5 μm.

The polyol component A) of the dispersion 1) essential to the invention, comprises

a) 0 to 100 parts by wt. of a polyester component comprising at least one polyester polyol with a hydroxyl number of 20 to 240 mg KOH/g at an acid number of <20 mg KOH/g and a glass transition temperature of −40 to +100° C.,

b) 0 to 15 parts by wt. of an olefinically unsaturated ester component comprising at least one maleic acid di(cyclo)alkyl ester having 1 to 12 carbon atoms in the (cyclo)alkyl radical,

c) 0 to 70 parts by wt. of (cyclo)alkyl esters of acrylic and/or methacrylic acid having 1 to 18 carbon atoms in the (cyclo)alkyl radical,

d) 0 to 70 parts by wt. of aromatic, olefinically unsaturated monomers,

e) 5 to 60 parts by wt. of hydroxyalkyl esters of acrylic and/or methacrylic acid having 2 to 4 carbon atoms in the hydroxyalkyl radical and/or reaction products thereof, with a maximum molecular weight of 500, with ε-caprolactone and addition products of acrylic and/or methacrylic acid and monoepoxide compounds, which can also be produced in situ during the free-radical polymerization,

f) 0 to 10 parts by wt. of olefinically unsaturated carboxylic acids and

g) 0 to 30 parts by wt. of further copolymerizable, olefinically unsaturated compounds,

the sum of the parts by wt. of components a) to g) giving 100.

The polyol component A) has a hydroxyl group content of 1 to 8 wt. %, preferably 1.5 to 6 wt. %, and particularly preferably 2 to 5 wt. %. The content of carboxyl groups is 0 to 3 wt. %, preferably 0.1 to 1.7 wt. %, and particularly preferably 0.2 to 1.3 wt. %. The molecular weight which can be determined by means of gel permeation chromatography (weight-average, polystyrene standard) is 2,000 to 50,000, preferably 2,500 to 40,000, and particularly preferably 3,000 to 35,000. The glass transition temperature according to differential thermal analysis (DTA) is >10° C., preferably 20 to 100° C., and particularly preferably 30 to 80° C.

The polyol component A) preferably comprises

a) 0 to 60 parts by wt. of a polyester component comprising at least one polyester polyol with a hydroxyl number of 30 to 200 mg KOH/g at an acid number of <15 mg KOH/g and a glass transition temperature of −30 to +80° C.,

b) 0 to 12.5 parts by wt. of an olefinically unsaturated ester component comprising at least one maleic acid di(cyclo)alkyl ester having 1 to 6 carbon atoms in the (cyclo)alkyl radical,

c) 5 to 65 parts by wt. of (cyclo)alkyl esters of acrylic and/or methacrylic acid having 1 to 15 carbons atoms in the (cyclo)alkyl radical,

d) 0 to 65 parts by wt. styrene, α-methylstyrene and/or vinyltoluene,

e) 5 to 55 parts by wt. of hydroxyalkyl esters of acrylic and/or methacrylic acid having 2 to 4 carbon atoms in the hydroxyalkyl radical and/or reaction products thereof, with a maximum molecular weight of 500, with ε-caprolactone and addition products of acrylic and/or methacrylic acid and monoepoxide compounds, which can also be produced in situ during the free-radical polymerization,

f) 0 to 7.5 parts by wt. acrylic acid, methacrylic acid, maleic acid, fumaric acid and/or maleic and/or fumaric acid half-esters having 1 to 8 carbon atoms in the alcohol radical and

g) 0 to 25 parts by wt. of further copolymerizable, olefinically unsaturated compounds,

the sum of the parts by wt. of components a) to g) giving 100.

Component A) particularly preferably comprises

a) 0 to 50 parts by wt. of a polyester component comprising at least one polyester polyol with a hydroxyl number of 40 to 160 mg KOH/g at an acid number of <12 mg KOH/g and a glass transition temperature of −30 to +70° C.,

b) 0 to 10 parts by wt. dimethyl maleate, diethyl maleate, dibutyl maleate or mixtures of these monomers,

c) 5 to 60 parts by wt. of (cyclo)alkyl esters of acrylic and/or methacrylic acid having 1 to 12 carbon atoms in the (cyclo)alkyl radical,

d) 5 to 50 parts by wt. styrene,

e) 10 to 50 parts by wt. hydroxyethyl acrylate, hydroxyethyl methacrylate, hydroxypropyl acrylate, hydroxypropyl methacrylate, hydroxybutyl acrylate and/or hydroxybutyl methacrylate,

f) 0.5 to 5 parts by wt. acrylic acid and/or methacrylic acid and

g) 0 to 20 parts by wt. of further copolymerizable, olefinically unsaturated compounds,

the sum of components a) to g) giving 100.

The polyester component a) is at least one hydroxy-functional polyester with a hydroxyl number of 20 to 240 mg KOH/g, preferably 30 to 200 mg KOH/g, and particularly preferably 40 to 160 mg KOH/g. The acid number is below 20 mg KOH/g, preferably below 15 mg KOH/g, and particularly preferably below 12 mg KOH/g. The glass transition temperature of polyester component a) is −40 to +100° C., preferably −30 to +80° C., and particularly preferably −30 to +70° C. The molecular weight of the polyester polyols, which can be calculated from the stoichiometry of the starting materials employed, is approx. 460 to 11,300 g/mol, preferably approx. 570 to 7,500 g/mol, and particularly preferably approx. 700 to 5,700 g/mol.

A total of 6 groups of monomer constituents can be used in the preparation of the hydroxy-functional polyesters:

1) (cyclo)alkanediols (i.e. dihydric alcohols with (cyclo)aliphatically bonded hydroxyl groups) of the molecular weight range from 62 to 286, such as e.g. ethanediol, 1,2- and 1,3-propanediol, 1,2-, 1,3- and 1,4-butanediol, 1,5-pentanediol, 1,6-hexanediol, neopentylglycol, cyclohexane-1,4-dimethanol,

1,2- and 1,4-cyclohexanediol, 2-ethyl-2-butylpropanediol and diols containing ether-oxygen, such as e.g. diethylene glycol, triethylene glycol, tetraethylene glycol, dipropylene glycol, tripropylene glycol, and polyethylene, polypropylene or polybutylene glycols with a maximum molecular weight of approx. 2,000, preferably approx. 1,000, and particularly preferably approx. 500. Reaction products of the abovementioned diols with ε-caprolactone can also be employed as diols.

2) Alcohols which are trihydric or more than trihydric of the molecular weight range from 92 to 254, such as e.g. glycerol, trimethylolpropane, pentaerythritol, dipentaerythritol and sorbitol.

3) Monoalcohols, such as e.g. ethanol, 1- and 2-propanol, 1- and 2-butanol, 1-hexanol, 2-ethylhexanol, cyclohexanol and be zyl alcohol.

4) Dicarboxylic acids of the molecular weight range from 116 to approx. 600 and/or anhydrides thereof, such as e.g. phthalic acid, phthalic anhydride, isophthalic acid, tetrahydrophthalic acid, tetrahydrophthalic anhydride, hexahydrophthalic acid, hexahydrophthalic anhydride, maleic anhydride, fumaric acid, succinic acid, succinic anhydride, adipic acid, dodecanedioic acid and hydrogenated dimer fatty acids.

5) Carboxylic acids of higher functionality and anhydrides thereof, such as e.g. trimellitic acid and trimellitic anhydride.

6) Monocarboxylic acids, such as e.g. benzoic acid, cyclohexanecarboxylic acid, 2-ethylhexanoic acid, caproic acid, caprylic acid, capric acid, lauric acid and naturally occurring and synthetic fatty acids.

In each case any desired mixtures of the monomer constituents 1) to 6) can be employed in the preparation of the polyester polyols a), with the proviso that the choice is made such that the resulting polyesters have both OH numbers in the range from 20 to 240 mg KOH/g at acid numbers of <20 mg KOH/g and glass transition temperatures of −40 to +100° C.

This condition is met if a suitable ratio of “plasticizing” monomer constituents, which lead to a lowering of the glass transition temperature of the polyesters, to “hardening” monomers, which lead to an increase in the glass transition temperature, is used in the preparation of the polyesters.

“Plasticizing” monomer constituents are, for example, aliphatic diols, such as e.g. 1,4-butanediol, 1,5-pentanediol and 1,6-hexanediol, or aliphatic dicarboxylic acids, such as e.g. adipic acid or dodecanedioic acid.

“Hardening” monomer constituents are, for example, cyclic aromatic dicarboxylic acids, such as e.g. phthalic acid, isophthalic acid and terephthalic acid, or diols, such as e.g. cyclohexane-1,4-diol, cyclohexane-1,4-dimethanol or neopentylglycol.

The polyesters a) are prepared in a manner known per se by methods such as are described in detail, for example, in “Ullnanns Enzyklopadie der technischen Chemie”, Verlag Chemie Weinheim, 4th edition (1980), volume 19, pages 61 et seq. or H. Wagner and H. F. Sarx in “Lack-kunstharze”, Carl Hanser Verlag, Munich (1971), pages 86 to 152. The esterification is optionally carried out in the presence of a catalytic amount of a conventional esterification catalyst, such as, for example, acids, such as e.g. p-toluenesulfonic acid, bases, such as e.g. lithium hydroxide, or transition metal compounds, such as e.g. titanium tetrabutylate, at approx. 80 to 260° C., preferably 100 to 240° C.

The esterification reaction is carried out until the required values for the hydroxyl and acid number are reached. The molecular weight of the polyester polyols can be calculated from the stoichiometry of the starting materials (taking into account the resulting hydroxyl and acid numbers).

Component b) comprises at least one maleic acid di(cyclo)alkyl ester having 1 to 12, preferably 1 to 8, and particularly preferably 1 to 4 carbon atoms in the (cyclo)alkyl radical. Suitable compounds are e.g. dimethyl maleate, diethyl maleate, di-n-butyl maleate, di-2-ethylhexyl maleate, di-n-decyl maleate, di-n-dodecyl maleate and dicyclohexyl maleate.

Component c) comprises at least one (cyclo)alkyl ester of acrylic and/or methacrylic acid having 1 to 18, preferably 1 to 15, and particularly preferably 1 to 12 carbon atoms in the (cyclo)alkyl radical, such as e.g. methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, cyclohexyl (meth)acrylate, 2-ethylhexyl (meth)acrylate, isobornyl (meth)acrylate, 3,3,5-trimethylcyclohexyl (meth)acrylate, stearyl (meth)acrylate and benzyl (meth)acrylate.

Component d) comprises at least one aromatic, olefinically unsaturated monomer, such as e.g. styrene, α-methylstyrene and vinyltoluene. Styrene is preferred.

Component e) comprises at least one hydroxyalkyl ester of acrylic and/or methacrylic acid having 2 to 6 carbon atoms in the hydroxyalkyl radical and/or reaction products thereof, with a maximum molecular weight of 500, with ε-caprolactone and addition products of acrylic and/or methacrylic acid and monoepoxide compounds, which can also be produced in situ during the free-radical polymerization. Compounds which can be employed are e.g. hydroxyethyl (meth)acrylate, hydroxypropyl (meth)acrylate, (isomer mixture formed by addition of propylene oxide on to (meth)acrylic acid), hydroxybutyl (meth)acrylate and reaction products of these monomers with ε-caprolactone up to a maximum molecular weight of 500. The term “hydroxyalkyl esters” is thus also to include radicals containing ester groups such as are formed by addition of ε-caprolactone on to simple hydroxyalkyl esters. Reaction products of acrylic and/or methacrylic acid with monoepoxide compounds, which can additionally also carry OH groups, are furthermore also to be regarded as “hydroxyalkyl esters of (meth)acrylic acid” and are therefore likewise suitable as monomers e). Examples of suitable monoepoxides are ®Cardura E 10 (Shell), 2-ethyl-hexyl glycidyl ether and glycidol (1,2-epoxy-2-propanol). These reaction products can also be produced in situ under the reaction conditions of the free-radical polymerization. The simple hydroxyalkyl esters (ethyl, propyl and butyl) of acrylic and/or methacrylic acid are preferred.

Component f) comprises at least one olefinically unsaturated carboxylic acid, such as e.g. acrylic acid, methacrylic acid, maleic acid, fumaric acid and/or maleic acid and/or fumaric acid half-esters having 1 to 18 carbon atoms in the alcohol radical. Acrylic and methacrylic acid are preferred.

Component g) comprises copolymerizable, olefinically unsaturated compounds which differ from the compound classes of components b) to f), such as, for example, α-olefins, such as e.g. 1-octene or 1-decene; vinyl esters, such as e.g. vinyl acetate, vinyl propionate, vinyl butyrate, ®VeoVa 9 and ®VeoVa 10 from Shell; other vinyl compounds, such as e.g. N-vinylpyrrolidone, N-vinylcaprolactam and N-vinylcarbazole, and also polyunsaturated compounds, such as e.g. hexanediol diacrylate, trimethylolpropane triacrylate, divinylbenzene and polybutadienes with a molecular weight of 500 to 10,000.

The polyol component A) is prepared by free-radical polymerization of components b) to g), either in an inert organic solvent or in bulk in the absence of solvent, e.g. in the presence of component a). Component a) is expediently initially introduced into the reaction vessel, but can also be employed in the free-radical polymerization as a mixture with monomer components b) to g). However, it is also possible to admix component a) to the finished polymer formed after polymerization of components b) to g). For the preparation of the polyol component A), in each case any desired mixtures can be used as starting substances a) to g) within the above-mentioned amounts contents limits, with the proviso that this choice is made such that the resulting polyol binders have hydroxyl numbers and glass transition temperatures within the abovementioned ranges.

This condition is met if a suitable ratio of “plasticizing” monomers, which lead to a lowering of the glass transition temperature, to “hardening” monomers, which lead to an increase in the glass transition temperature, are used for the preparation of the copolymers.

“Plasticizing” monomers are, for example, alkyl esters of acrylic acid, such as e.g. ethyl acrylate, n-butyl acrylate, isobutyl acrylate and 2-ethylhexyl acrylate.

“Hardening” monomers are, for example, short-chain (cyclo)alkyl esters of methacrylic acid, such as e.g. methyl methacrylate, ethyl methacrylate, isopropyl methacrylate, isobutyl methacrylate, tert-butyl methacrylate, cyclohexyl methacrylate, neopentyl methacrylate, isobornyl methacrylate and 3,3,5-trimethylcyclohexyl methacrylate; and vinylaromatics, such as e.g. styrene, vinyltoluene and α-methylstyrene.

Suitable initiators for carrying out the free-radical polymerization are conventional free radical initiators, such as e.g. aliphatic azo compounds, such as azodiisobutyronitrile, azo-bis-2-methylvaleronitrile, 1,1′-azo-bis-1-cyclohexanenitrile and 2,2′-azo-bis-isobutyric acid alkyl esters; symmetric diacyl peroxides, such as e.g. acetyl, propionyl or butyryl peroxide, benzoyl peroxides and lauryl peroxides substituted by bromine, nitro, methyl or methoxy groups; symmetric peroxydicarbonates, e.g. diethyl, diisopropyl, dicyclohexyl and dibenzoyl peroxydicarbonate; tert-butyl peroxy-2-ethylhexanoate and tert-butyl perbenzoate; hydroperoxides, such as, for example, tert-butyl hydroperoxide and cumene hydroperoxide; and dialkyl peroxides, such as dicumyl peroxide, tert-butyl cumyl peroxide, di-tert-butyl peroxide or di-tert-amyl peroxide.

Suitable solvents for the preparation of the polyol component A) are e.g. those solvents which can be removed from the aqueous state of a dispersion by vacuum distillation after the emulsifying step and are preferably inert towards isocyanate groups. Examples which may be mentioned are ketones, such as acetone and methyl ethyl ketone, and esters, such as ethyl acetate and butyl acetate, and aromatics, such as toluene and xylene.

For the preparation of the polyol binders A), a reaction medium for the free-radical polymerization is initially introduced into a polymerization reactor and is heated up to the desired polymerization temperature. A solvent or a mixture of the abovementioned solvents, if envisaged for use, e.g. can serve as the polymerization medium or the polyester component a) or also component b). It is also possible to employ any desired combinations of solvent and components a) and/or b) as the reaction medium. After the desired polymerization temperature is reached, the monomer mixture comprising components c) to g) and optionally a) and/or b) and the free radical initiator are metered into the reaction medium, preferably starting at the same time. By this procedure, the olefinically unsaturated constituents of the monomer mixture are subjected to free-radical copolymerization, the polyester a) optionally employed being bonded chemically to the copolymer by grafting reactions, which can take place to a greater or lesser degree under the reaction conditions. The polyester component a) preferably contains no unsaturated double bonds. However, in order to achieve specific product properties it may also be indicated to employ polyesters which have a low content of polymerizable double bonds and thus can undergo copolymerization reactions.

The polymerization temperature is 80 to 220° C., preferably 90 to 200° C., and particularly preferably 120 to 1 80° C.

Conventional regulators can be employed when carrying out the polymerization in order to regulate the molecular weight of the polyol binders. Mercaptans, such as e.g. tert-dodecylmercaptan, n-dodecyhnercaptan and mercaptoethanol, may be mentioned as regulators by way of example.

The polymerization is in general carried out in a closed pressurized polymerization reactor with automatic temperature control under a pressure of up to 20 bar, especially if solvents of the abovementioned type are co-used. In the case of a solvent-free procedure and if high-boiling monomer constituents are used, the polymerization can also be carried out under atmospheric pressure.

The polyol binders A) obtained by the polymerization process described are valuable binder components for the preparation of the aqueous powder suspensions according to the invention and form the essential polyol constituent, optionally in addition to further components C) containing hydroxyl groups, which can be employed in minor amounts in addition to the polyol component A) if required.

Component B) comprises blocked polyisocyanates, preferably (cyclo)aliphatic polyisocyanates containing biuret, isocyanurate, urethane, uretdione, allophanate and/or iminooxadiazinedione groups. Polyisocyanates which contain several of these groups mentioned can also be employed. The known (cyclo)aliphatic diisocyanates, from which the polyisocyanates are prepared by known processes, such as e.g. trimerization, allophanation, urethanization or biuretization, can be employed for the preparation of the polyisocyanates. 1,6-Diisocyanatohexane (HDI), 1-isocyanato-3,3,5-trimethyl-5-isocyanatomethylcyclohexane (isophoronediisocyanate, IPDI), 2,4- and/or 2,6-diisocyanato-1-methylcyclohexane and 4,4′-diisocyanatodicyclohexylmethane ®Desmodur W, Bayer AG) are preferably used. Polyisocyanates based on 1,6-diisocyanatohexane, isophorone-diisocyanate and ® Desmodur W are particularly preferably employed for the preparation of component B).

For the preparation of the polyisocyanate component B), the above-mentioned polyisocyanates are blocked with conventional blocking agents in a blocking reaction known per se and optionally modified hydrophilically.

Blocking agents which are employed are the known monofunctional blocking agents, such as e.g. dimethyl malonate, diethyl malonate, ethyl acetoacetate, ε-caprolactam, butanone oxime, cyclohexanone oxime, 1,2,4-triazole, dimethyl-1,2,4-triazole, 3,5-dimethylpyrazole, imidazole, di-n-propylamine, diisopropylamine, di-n-butylamine, diisobutylamine or dicyclohexylamine. Blocking agents which split off in the temperature range up to 180° C., particularly preferably up to 160° C., are preferably employed. Butanone oxime, cyclohexanone oxime, 3,5-dimethylpyrazole and 1,2,4-triazole are preferred.

If the polyisocyanate component B) is modified hydrophilically, this is effected by methods known per se, i.e. by reacting some of the isocyanate groups with hydroxycarboxylic acids, e.g. 2,2-dimethylolpropionic acid or 3-hydroxy-2,2-dimethylpropanoic acid (hydroxypivalic acid) and/or with monofunctional polyethers with a content of ethylene oxide of at least 70 wt. %. In the case of modification with hydroxycarboxylic acids, at least partial neutralization with preferably an amine is necessary for the dissolving or dispersing in water, in order to produce ionic groups.

For the preparation of crosslinking component B), the polyisocyanate is reacted successively in any desired sequence or simultaneously with the blocking agent and/or the hydroxycarboxylic acid and/or the polyether. Preferably, the polyisocyanates are not hydrophilized but only blocked. Both a slight excess and a slight deficit of blocking agent can be employed here. In the case of a deficit of blocking agent, work can be continued if small contents of unreacted isocyanate groups are still present in the reaction mixture. The reactions are as a rule carried out in a temperature range from 10 to 120° C., preferably at 20 to 120° C., the reactions with hydroxycarboxylic acids in particular being carried out under mild conditions in order to prevent the carboxyl groups from also reacting with the isocyanate groups.

The reactions can be carried out without a solvent or in an inert solvent. The reaction in inert solvents is preferred, the abovementioned solvents preferably being used, in particular ethyl acetate, butyl acetate, acetone and methyl ethyl ketone, toluene and xylene.

When the reaction has ended, if hydrophilization with a carboxylic acid has taken place, at least partial neutralization of the carboxyl groups incorporated is optionally carried out with a neutralizing agent. Suitable neutralizing agents are alkali metal or alkaline earth metal hydroxides, but preferably ammonia and amines, such as e.g. triethylamine, triethanolamine, N-methylmorpholine and, particularly preferably, N,N-dimethylethanolamine. In general, the carboxyl groups optionally present are at least 50% neutralized, in which case an excess of neutralizing agent can optionally also be employed.

The further polyols C) optionally used are substances with at least one hydroxyl group, such as e.g. the low molecular weight alcohols already described for the preparation of the polyester polyols, and furthermore polyether alcohols having 1 to 6 hydroxyl end groups, polyurethane polyols having at least one hydroxyl end group, further polyester and/or polyacrylate polyols or ε-caprolactone polyesters with at least one hydroxyl end group.

The additional crosslinking component D) optionally employed comprises substances which, like the crosslinking substances B), lead to curing of the coatings according to the invention by chemical reaction with the hydroxyl groups of component A) and optionally C). Examples which may be mentioned are aminoplast resins, e.g. corresponding melamine derivatives, such as alkoxylated melamine resins or melamine-formaldehyde condensation products (e.g. FR-A 943 411, “The Chemistry of Organic Filmformers”, pages 235-240, John Wiley & Sons Inc., New York 1974) and conventional crosslinking agents, e.g. epoxides, carboxylic acid anhydrides, phenoplast resins, resol resins, urea resins or guanidine resins or mixtures thereof, which are reactive with alcoholic hydroxyl groups.

The external emulsifiers E) optionally used are conventional emulsifiers or dispersing agents such as are described, for example, by Johann Bielmann in Lackadditive, WILEY-VCH Verlag GmbH Weinheim, New York, Chichester, Brisbane, Singapore, Toronto 1998, pages 87-92. Particularly suitable substances E) are, for example, addition products of ethylene oxide and optionally propylene oxide on hydrophobic starter molecules, such as e.g. nonylphenol, phenol/styrene condensates and long-chain, optionally branched alcohols, such as lauryl alcohol or stearyl alcohol. However, ionic compounds of this type, such as, for example, sulfuric or phosphoric acid ester salts containing ethylene oxide and optionally propylene oxide units, as described e.g. in WO 97/31960, are also suitable as substances E).

The conventional additives F) optionally employed are, for example, neutralizing agents, catalysts, auxiliary substances and/or additives, such as e.g. degassing agents, wetting and dispersing agents, flow agents, agents which trap free radicals, antioxidants and/or UV absorbers, thickeners, small amounts of solvents and biocides.

The polyhydroxy component II) comprises, for example, water-soluble or -dispersible polyhydroxy compounds of a number-average molecular weight, which can be determined by gel permeation chromatography (polystyrene standard), of 1,000 to 100,000, preferably 2,000 to 20,000, of the type known per se from polyurethane lacquer chemistry, provided the polyhydroxy compounds have a content of hydrophilic groupings, in particular polyether chains containing carboxylate groups and/or ethylene oxide units, sufficient for their solubility or dispersibility in water. However, the use of polyhydroxy compounds which are not sufficiently hydrophilic by themselves as a mixture with external emulsifiers is in principle also possible.

Possible components II) are polyhydroxypolyesters, polyhydroxypolyethers, polyhydroxypolyurethanes, polyhydroxycarbonates, urethane-modified polyester polyols, urethane-modified polyether polyols, urethane-modified polycarbonate polyols or polymers containing hydroxyl groups, i.e. the polyhydroxy-polyacrylates known per se. However, mixtures of these polyhydroxy compounds mentioned or optionally grafted representatives of combinations of these polyhydroxy compounds prepared in situ, such as e.g. polyester-polyacrylate polyols, polyether-polyacrylate polyols, polyurethane-polyacrylate polyols, polyester-polyurethanes, polyether-polyurethanes, polycarbonate-polyurethanes and polyether-polyesters or mixtures thereof, can also be employed as component II).

The polyacrylate polyols are copolymers which are known per se of simple esters of acrylic and/or methacrylic acid, hydroxyalkyl esters, such as, for example, the 2-hydroxyethyl, the 2-hydroxypropyl or the 2-, 3- or 4-hydroxybutyl ester, of these acids being co-used to introduce the hydroxyl groups and acrylic and/or methacrylic acid being co-used to introduce carboxyl groups which can be neutralized with amines for conversion to carboxylate groups. Olefinically unsaturated compounds, such as e.g. vinylaromatics, acrylonitrile, maleic acid di(cyclo)alkyl esters, vinyl esters, vinyl ethers etc., are possible further comonomers.

The polymers can be prepared on the one hand directly in water with the aid of emulsifiers, emulsion copolymers, which are also called “primary dispersions”, being formed. On the other hand, preparation in organic solvents, and, after introduction of ionic groups, subsequent conversion into the aqueous phase is also possible, so-called “secondary dispersions” being obtained.

Suitable polyether polyols are the ethoxylation and/or propoxylation products, which are known per se from polyurethane chemistry, of suitable 2- to 6-functional starter molecules, such as e.g. water, ethylene glycol, propanediol, trimethylolpropane, glycerol, pentaerythritol and/or sorbitol.

Examples of suitable polyester polyols are, in particular, the reaction products, which are known per se in polyurethane chemistry, of polyhydric alcohols, for example of alkane-polyols of the type just mentioned by way of example, with deficits of polycarboxylic acids or polycarboxylic acid anhydrides, in particular dicarboxylic acids or dicarboxylic acid anhydrides. Suitable polycarboxylic acids or polycarboxylic acid anhydrides are, for example, adipic acid, phthalic acid, isophthalic acid, phthalic anhydride, tetrahydrophthalic anhydride, hexahydrophthalic anhydride, maleic acid, maleic anhydride, Diels-Alder adducts thereof with cyclopentadiene, fumaric acid or dimeric or trimeric fatty acids. In order to establish specific molecular weights or functionalities of the polyester polyols, there is also the possibility of using monofunctional alcohols, such as e.g. 2-ethylhexanol or cyclohexanol, and/or monofunctional carboxylic acids, such as e.g. 2-ethylhexanoic acid, benzoic acid or cyclohexanecarboxylic acid. Any desired mixtures of mono- and polyfunctional alcohols or any desired mixtures of mono- and polyfunctional carboxylic acids or carboxylic acid anhydrides can of course be employed in the preparation of the polyester polyols.

The polyester polyols are prepared by known methods, such as are described e.g. in Houben-Weyl, Methoden der organischen Chemie, volume XIV/2, G. Thieme-Verlag, Stuttgart, 1963, pages 1 to 47.

The hydrophilic modification of these polyester polyols which is optionally required is carried out by methods known per se, such as are disclosed, for example, in EP-A 0 157 291 or EP-A 0 427 028. The water-soluble or -dispersible urethane-modified polyesters described in these publications are particularly suitable according to the invention as component II). Urethane-modified polyester resins such as are described in DE-A 42 21 924 are particularly preferably possible as component II). The water-soluble or -dispersible polyacrylates containing hydroxyl groups described in DE-A 38 29 587 are also suitable, but less preferred.

Possible polyfunctional crosslinking resins III) are both water-soluble or -dispersible blocked polyisocyanates and water-soluble or -dispersible amino resins, such as e.g. melamine resins. The water-soluble or -dispersible polyisocyanates such as have also already been mentioned before in the prior art are in principle suitable. However, the water-soluble or -dispersible blocked polyisocyanates described in DE-A 42 21 924 and DE-A 198 10 660 are particularly suitable.

It is also possible for already finished mixtures of representatives of components II) and III) to be used as combination partners for the component I) essential to the invention. Such finished mixtures are already employed in practice because of their good storage stability at room temperature.

Epoxy resins, phenolic resins, polyamine resins, low molecular weight epoxy crosslinking agents and low molecular weight polyamine crosslinking agents, for example, can be used as further water-dispersible substances IV).

The dispersions I) essential to the invention can be prepared either by a direct dispersing process or by the phase inversion process.

Dispersing devices with a high dispersing output per unit volume, such as e.g. pressure release homogenizing jets, are used for the preparation of the dispersions I) essential to the invention by dispersing processes.

Corresponding dispersing machines are known e.g. from Formation of Emulsions, in P. Beche, Encyclopaedia of Emulsion Technology, vol. 1, New York, Basle, Decker 1983, but have not hitherto been employed for the preparation of such aqueous dispersions for aqueous stoving filler compositions.

Dispersing machines are chosen according to the output per unit volume. For the preparation of finely divided dispersions (particle diameter approx. 1 μm), dispersing machines with high outputs per unit volume, e.g. high-pressure homogenizers, are required. Such finely divided dispersions can no longer be prepared well with rotor/stator machines. The jet disperser described in EP-A 0 101 007 is a specific pressure release jet which has a substantially higher efficiency than high-pressure homogenizers. Particle size distributions for which 200 bar are required in a high-pressure homogenizer are already achieved with the jet disperser under a homogenizing pressure of 50 bar.

Finely divided dispersions can be particularly advantageously prepared both continuously and discontinuously with the jet disperser as the dispersing device.

According to the invention, the aqueous dispersion can also be converted from a water-in-oil emulsion into an oil-in-water emulsion by phase inversion.

The aqueous dispersions 1) which are prepared according to the invention and are essential to the invention can be used in combination with components II), III) and optionally IV) for stoving lacquering on any desired heat-resistance substrates, e.g. as filler compositions and base or top lacquers for the production of one-coat and/or multi-coat lacquerings, for example in the motor vehicle sector. The preferred use is in the filler composition sector.

To prepare the coating compositions I) according to the invention, the components A), B) and optionally C) to F) described are mixed with one another, preferably in the solvents already mentioned. Ethyl acetate and methyl ethyl ketone are preferred as the solvent, and methyl ethyl ketone is particularly preferred. Components A) and B) can of course also be prepared directly in solution and these solutions can then be mixed. Particularly preferably, components A) and B) are prepared in methyl ethyl ketone and then mixed.

Further polyfunctional crosslinking substances, neutralizing agents, small amounts of external emulsifiers and further auxiliary substances and additives, such as e.g. thickeners, flow agents, light stabilizers and/or catalysts, can optionally be introduced into this solution of A) and B), if required and if this has not yet been done beforehand. Thereafter, the organic solution is mixed with water to prepare the aqueous suspensions. This is carried out either by the direct dispersing process, in which case the organic phase is dispersed in the aqueous phase, or by the phase inversion process, in which case a water-in-oil emulsion initially present is converted into an oil-in-water emulsion. This is carried out with the aid of a dispersing device with a high dispersing output per unit volume. This can be e.g. a cage stirrer, dissolver, rotor/stator mixer or pressure release jets, preferably jet dispersers, the dispersing output per unit volume for the dispersing process being 1 to 10⁸ W/cm³, preferably 1 to 5·10⁷ W/cm³, and particularly preferably 1 to 3·10⁷ W/cm³. The average particle size of the particles of the aqueous dispersions or suspensions is 0.05 to 10 μm, preferably 0.1 to 5 μm, in particular 0.15 to 2.5 μm, and particularly preferably 0.2 to 1.5 μm.

To obtain specific particle size distributions, it is appropriate and advantageous to carry out the dispersing in several stages at a defined output per unit volume.

It has proved advantageous first to prepare a pre-emulsion by means of a stirrer or dissolver before the dispersing operation by the jet disperser, and then to feed this pre-emulsion to the jet disperser. For the preparation of the dispersions or emulsions, water is used in an amount such that 20 to 75 wt. %, preferably 30 to 70 wt. %, and particularly preferably 35 to 70 wt. % dispersions or emulsions of the binders I) essential to the invention result. When the addition of water has ended, the solvent is preferably removed by distillation in vacuo.

The dispersing can take place in a broad temperature range, both at a low temperatures, such as e.g. 10° C., and at a high temperature up to significantly above the melting point of the polymer mixture, such as e.g. 150° C. At such high temperatures, only a brief exposure to heat in the range of seconds is possible because of the reactivity of the binder systems.

In principle, however, a procedure for the preparation of the aqueous dispersions or suspensions which comprises mixing mixtures of A) and B) containing free carboxyl and hydroxyl groups and blocked isocyanate groups, optionally in the form of an organic solution in one of the solvents mentioned by way of example, with an aqueous solution of a neutralizing agent of the type mentioned, so that neutralization and the dissolving or dispersing operation take place in one stage, would also be possible.

The mixing ratio of the polyhydroxy component A) to the blocked polyisocyanate component B) is chosen such that the equivalent ratio of blocked isocyanate groups of component B) to alcoholic hydroxyl groups of component A) is 0.5:1 to 2:1, preferably 0.6:1 to 1.8:1, and particularly preferably 0.7:1 to 1.5:1.

Further polyfunctional hydroxy compounds C), polyfunctional crosslinking agents D), external emulsifiers E) and conventional additives F) can be added to the aqueous binder mixture and also the individual components A) and B) before the combining operation or already during the preparation or to the mixture of A) and B) before the dispersing operation. In the case of water-soluble or -dispersible substances C) to F), these can also be added to the aqueous phase after the dispersing and distillation.

To prepare ready-to-use coating compositions, in particular filler compositions, the specific dispersions 1) essential to the invention are mixed with the polyhydroxy compounds II), the crosslinking agents III) and optionally representatives of component IV). The mixing ratio in respect of components 1) to III) is in the range from 90:5:5 to 10:45:45 wt. %, preferably 85:7.5:7.5 to 15:42.5:42.5 wt. %, and particularly preferably 80:10:10 to 20:40:40 wt. %, based on the solid. Representatives of component IV) can optionally be employed in amounts of up to 20 wt. %, preferably 10 wt. %, based on the solid. Particularly preferably, only mixtures of components I) to III) are employed. The one-component binders obtained in this way can in general be stored for any desired length of time. Auxiliary substances and additives of coating technology which are optionally to be co-used, such as, for example, pigments, fillers, flow agents, wetting and dispersing agents, bubble-preventing agents, catalysts and the like, can be added to the aqueous binder or binder mixture and/or the individual components I), II), III) and optionally IV). It is of particular advantage to process the individual components I), II), III) and optionally IV) or I) and the mixture of II) and III) with auxiliary substances, pigments and fillers to give ready-to-use pastes, which can then be mixed with one another as desired within the abovementioned limits. Quite specific properties for specific requirements can be achieved in this manner. There is also the possibility of already adding some additives, such as e.g. flow agents or catalysts, to component I) before dispersion thereof in water.

The one-component coating compositions comprising the dispersions I) essential to the invention can be applied by any desired methods of all those of coating technology, such as e.g. spraying, brushing, dipping, flooding or with the aid of rollers and doctor blades, to any desired heat-resistant substrates in one or several layers.

For example, coatings are obtained on metal, plastic, wood or glass by curing the lacquer film at 80 to 220° C., preferably 100 to 200° C., and particularly preferably 120 to 180° C.

The binders according to the invention are preferably suitable for the production of coatings and lacquerings on steel sheets, such as are used, for example, for the production of vehicle bodies, machines, panelling, drums or containers. They are preferably used for the preparation of car filler compositions. The lacquer films in general have a dry layer thickness of 0.01 to 0.3 mm.

The binders according to the invention give a long-lasting surface protection, as is demonstrated in the examples. The surprisingly high impact strength with a simultaneously high film hardness, which are in themselves contradictory properties, is to be singled out in particular. This makes the binders outstandingly suitable for uses where a good protection against flying stones coupled with a high lacquer film hardness is required.

The particular advantage of the new aqueous binders is, in addition their high stability during storage both at room temperature and at slightly elevated temperatures of 30 to 60° C., the particularly high solids content of >55 wt. % which is to be achieved under application conditions, which as a general rule is not achieved by aqueous binders known to date.

The following examples illustrate the invention, but without limiting it.

### EXAMPLES

All the percentage data relate to the weight, unless noted otherwise.

1. Preparation of the Dispersions I) Essential to the Invention

Polyol Component A)

General Working Instructions for the Preparation of a Polyester-Polyacrylate Polyol or Polyacrylate Polyol:

Part I is initially introduced under a nitrogen atmosphere into a 10 1 high-grade steel pressure reactor with a stirring, cooling and heating device and electronic temperature control and is heated up to the reaction temperature. Part II (addition over a period of 3 hours in total) and part III (addition over a period of 3.5 hours in total) are then metered into the closed reactor, starting at the same time, at a constant temperature of the reactor contents. After the addition of part m, the mixture is subsequently stirred at the polymerization temperature for 1 hour. The resin solution formed is then cooled to 30° C. and filtered.

The reaction temperatures and the compositions of parts I to III are listed in table 1 together with the characteristic data of the products obtained.

Starting Material:

Polyester: Polyester polyol of hydroxyl number 98 mg KOH/g and acid number 1.5 mg KOH/g, prepared by reaction of 22.07 parts by wt. 2-ethylhexanoic acid, 30.29 parts by wt. trimethylolpropane, 12.67 parts by wt. neopentylglycol, 32.24 parts by wt. hexahydrophthalic anhydride and 12.29 parts by wt. adipic acid.

TABLE 1
Polyols A) of the binders I) essential to the invention
(amounts data in g)

| Polyol | A1 | A2 | A3 |
|---|---|---|---|
| Part I | | | |
| Methyl ethyl ketone | 2,000 | 2,000 | 2,000 |
| Polyester | 568 | — | — |
| Dimethyl maleate | 284 | — | — |
| Part II | | | |
| Methyl methacrylate | 1,136 | 1,136 | 1,562 |
| Styrene | 2,037 | 1,673 | 1,673 |
| Hydroxyethyl methacrylate | 922 | 1,735 | 1,735 |
| Butyl methacrylate | 568 | — | — |
| Butyl acrylate | — | 852 | 426 |
| Acrylic acid | 51 | 57 | 57 |
| Part III | | | |
| Di-tert-butyl peroxide | 114 | 227 | 227 |
| Methyl ethyl ketone | 320 | 320 | 320 |
| Polymerization temperature | 160° C. | 160° C. | 160° C. |
| Characteristic data: | | | |
| Solids content, % | 69.1 | 69.7 | 69.1 |
| Viscosity at 23° C., mPa · s | 1,940 | 1,200 | 1,490 |
| Acid number, mg KOH/g | 5.6 | 7.5 | 7.6 |
| OH number, mg KOH/g | 56 | 92 | 91 |
| OH content of solid resin, % | 2.46 | 4.0 | 4.0 |
| Hazen colour number, APHA | 40 | 10 | 20 |

Preparation of the Crosslinking Component B)

Polyisocyanate 1:

1,332 g isophorone-diisocyanate (IPDI) are initially introduced under nitrogen into a 2 l four-necked flask with a stirrer, gas inlet tube, internal thermometer, dropping funnel and reflux condenser and are heated to 80° C. 15 ml of a 5 wt. % solution of 2-hydroxypropyltrimethylammonium hydroxide in 2-ethyl-1,3-hexanediol/methanol (6:1, parts by wt.) are slowly and uniformly added dropwise from a dropping funnel in the course of 45 minutes. During this operation the temperature rises to 88° C. (90° C. should not be exceeded because the trimerization proceeds non-specifically at too high temperatures and leads to higher viscosities of the end product). When the dropwise addition has ended, the reaction mixture is stirred at 80° C. until it has reached an NCO content of 30.6%. The reaction is then stopped by addition of 0.36 g (70 ppm molar) of a 25% solution of dibutyl phosphate in IPDI. Excess monomeric IPDI is removed by thin film distillation. A virtually colourless, clear resin is obtained with a yield of 44%, and is dissolved 70% in methyl ethyl ketone. The viscosity of the solution at 23° C. is 300 mPa.s, the isocyanate content is 11.8% and the content of free monomeric IPDI is 0.18%.

Polyisocyanate 2:

®Desmodur N 3300 (Bayer AG), solids content: 100%; viscosity at 23° C.: 3,500 mPa.s; isocyanate content: 21.8%.

Polyisocyanate 3:

524.00 g 4,4′-diisocyanatodicyclohexylmethane ®Desmodur W, Bayer AG) and 146.24 g 2,2,4-trimethyl-1,3-pentanediol are initially introduced under nitrogen into a 2 1 four-necked flask with a stirrer, gas inlet tube, internal thermometer and reflux condenser and are heated to 100° C. 1 ml dibutyltin dilaurate is slowly added dropwise (exothermic reaction), while stirring, such that a temperature of 120° C. is not exceeded. When the dropwise addition has ended, the reaction mixture is stirred at 100° C. until it has reached an NCO content of 12.5%. A virtually colourless clear resin is obtained and, after cooling to 75° C., is dissolved in 445.83 g methyl ethyl ketone. The flow time of the 60% solution is 23 s (ISO 4 cup, 23° C.) and the isocyanate content is 7.5%.

Preparation of a Blocked Polyisocyanate B 1:

500 g polyisocyanate 1 are initially introduced into a 111 four-necked flask with a stirrer, internal thermometer and reflux condenser and are heated to 60° C. 134.86 g 3,5-dimethylpyrazole are added in portions, while stirring, and the mixture is then stirred at 60° C. until the isocyanate band is no longer to be seen in the IR spectrum.

Preparation of a Blocked Polyisocyanate B 2:

500 g polyisocyanate 1 are initially introduced into a 1 l four-necked flask with a stirrer, internal thermometer, reflux condenser and dropping funnel and are heated to 60° C. 122.22 g butanone oxime are then added dropwise in the course of 30 minutes, while stirring. The mixture is stirred at 60° C. until the isocyanate band is no longer to be seen in the IR spectrum.

Preparation of a Blocked Polyisocyanate B 3:

500 g polyisocyanate 1 are initially introduced into a 111 four-necked flask with a stirrer, internal thermometer and reflux condenser and are heated to 60° C. 158.74 g cyclohexanone oxime are added in portions, while stirring, and the mixture is then stirred at 60° C. until the isocyanate band is no longer to be seen in the IR spectrum.

Preparation of a Blocked Polyisocyanate B 4:

150 g methyl ethyl ketone are added to 350 g polyisocyanate 2 in a 1 l four-necked flask with a stirrer, internal thermometer and reflux condenser and the mixture is heated to 50° C., while stirring. 205.28 g cyclohexanone oxime are then added in portions and the mixture is stirred at 50° C. until the isocyanate band is no longer to be seen in the IR spectrum.

Preparation of a Blocked Polyisocyanate B 5:

385.40 g polyisocyanate 2 are initially introduced into a 111 four-necked flask with a stirrer, internal thermometer and reflux condenser and are heated to 60° C. 192.26 g 3,5-dimethylpyrazole are added in portions, while stirring, and the mixture is then stirred at 60° C. until the isocyanate band is no longer to be seen in the IR spectrum.

Preparation of a Blocked Polyisocyanate B 6:

385.40 g polyisocyanate 2 are initially introduced into a 111 four-necked flask with a stirrer, internal thermometer and reflux condenser and are heated to 60° C. 138.14 g 1,2,4-triazole are added in portions, while stirring, and the mixture is then stirred at 60° C. until the isocyanate band is no longer to be seen in the IR spectrum.

Preparation of a Blocked Polyisocyanate B 7:

560.00 g polyisocyanate 3 are initially introduced into a 111 four-necked flask with a stirrer, internal thermometer and reflux condenser and are heated to 60° C. 96.13 g 3,5-dimethylpyrazole are added in portions, while stirring, and the mixture is then stirred at 60° C. until the isocyanate band is no longer to be seen in the IR spectrum.

Preparation of a Blocked Polyisocyanate B 8:

560.00 g polyisocyanate 3 are initially introduced into a 1 l four-necked flask with a stirrer, internal thermometer and reflux condenser and are heated to 60° C. 69.07 g 1,2,4-triazole are added in portions, while stirring, and the mixture is then stirred at 60° C. until the isocyanate band is no longer to be seen in the IR spectrum.

Preparation of the Aqueous Dispersions I) Essential to the Invention

Dispersion I.1):

397.2 g of the polyester-polyacrylate polyol A 1 and 190.4 g of the blocked polyisocyanate B 1 are dissolved in 456 g methyl ethyl ketone (MEK), and 3 g of the neutralizing agent dimethylethanolamine are added. 12.6 g Emulsifier WN (emulsifying auxiliary, Bayer AG) are then added and a homogeneous mixture of the components is prepared by stirring.

A water-in-oil emulsion is prepared from 963 g of the solution of polyol, polyisocyanate, neutralizing agent and additive in MEK by intensive mixing with 500 g water by means of a dissolver, and then undergoes a phase inversion into an oil-in-water emulsion by passage through a jet disperser under increased pressure (60 bar) according to EP 0101007. The MEK is distilled off in vacuo. The emulsion is then subsequently stabilized with 6 g Emulsifier WN. It is then filtered through a filter of mesh width 10 μm. A polymer dispersion with the following characteristic data results:

| | |
|---|---|
| Flow time (ISO 4 cup, 23° C.): | 13 sec |
| Solids content: | 44.3 wt. % |
| Average particle size (laser correlation spectroscopy): | 0.22 μm |
| Glass transition temperature: | 61° C. |

Dispersion I.2)

303.6 g of the polyacrylate polyol A 2 and 220.0 g of the blocked polyisocyanate B 2 are dissolved in 440.5 g MEK and 2.7 g of the neutralizing agent dimethylethanolamine are added. 11.4 g Emulsifier NP 30 (emulsifying auxiliary, Bayer AG) are then added and a homogeneous mixture of the components is prepared by stirring.

A water-in-oil emulsion is prepared from 825 g of the solution of polyol, polyisocyanate, neutralizing agent and additive in MEK by intensive mixing with 500 g water by means of a dissolver, and then undergoes a phase inversion into an oil-in-water emulsion by passage through a jet disperser under increased pressure (1.0 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 9 sec |
| Solids content: | 34.0 wt. % |
| Average particle size (laser correlation spectroscopy): | 0.37 μm |
| Glass transition temperature: | 53° C. |

Dispersion I.3): 303.5 g of the polyacrylate polyol A 2, 157.8 g of the blocked polyisocyanate B 3 and 64.9 g of the blocked polyisocyanate B 4 are dissolved in 446.2 g MEK and 2.7 g of the neutralizing agent dimethylethanolamine are added. 11.5 g Emulsifier NP 30 are then added and a homogeneous mixture of the components is prepared by stirring.

A water-in-oil emulsion is prepared from 954 g of the solution of polyol, polyisocyanate, neutralizing agent and additive in MEK by intensive mixing with 500 g water by means of a dissolver, and then undergoes a phase inversion into an oil-in-water emulsion by passage through a jet disperser under increased pressure (1.0 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 15 sec |
| Solids content: | 47.0 wt. % |
| Average particle size (laser correlation spectroscopy): | 0.35 μm |
| Glass transition temperature: | 47° C. |

Dispersion I.4)

305.0 g of the polyacrylate polyol A 2, 77.7 g of the blocked polyisocyanate B 3 and 131.1 g of the blocked polyisocyanate B 4 are dissolved in 204.4 g MEK and 2.7 g of the neutralizing agent dimethylethanolamine are added. 11.3 g Emulsifier NP 30, dissolved in 50 g MEK, are then added and a homogeneous mixture of the components is prepared by stirring.

A water-in-oil emulsion is prepared from 770 g of the solution of polyol, polyisocyanate, neutralizing agent and additive in MEK by intensive mixing with 400 g water by means of a dissolver, and then undergoes a phase inversion into an oil-in-water emulsion by passage through a jet disperser under increased pressure (1.0 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 20 sec |
| Solids content: | 56.0 wt. % |
| Average particle size (laser correlation spectroscopy): | 0.35 μm |
| Glass transition temperature: | 38° C. |

Dispersion I.5):

308.5 g of the polyacrylate polyol A 3 and 222.0 g of the blocked polyisocyanate B 2, are dissolved in 441.5 g MEK, and 2.7 g of the neutralizing agent dimethylethanolamine are added. 11.4 g Emulsifier NP 30 are then added and a homogeneous mixture of the components is prepared by stirring.

A water-in-oil emulsion is prepared from 957 g of the solution of polyol, polyisocyanate, neutralizing agent and additive in MEK by intensive mixing with 500 g water by means of a dissolver, and then undergoes a phase inversion into an oil-in-water emulsion by passage through a jet disperser under increased pressure (1.0 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 14 sec |
| Solids content: | 43.1 wt. % |
| Average particle size (laser correlation spectroscopy): | 0.42 μm |
| Glass transition temperature: | 52° C. |

Dispersion I.6):

364.58 g of the polyacrylate polyol A 2, 36.11 g of the blocked polyisocyanate B 5 and 328.12 g of the blocked polyisocyanate B 7 are dissolved in 529.40 g MEK, and 3.35 g of the neutralizing agent dimethylethanolamine are added. 16.78 g Emulsifier WN (emulsifying auxiliary, Bayer AG) and 7.55 g Synperonic PE/F 127 (emulsifying auxiliary, ICI Surfactants) are then added and a homogeneous mixture of the components is prepared by stirring.

A water-in-oil emulsion is prepared from 1,008.26 g of the solution of polyol, polyisocyanate, neutralizing agent and additives in MEK by intensive mixing with 500.00 g water by means of a dissolver, and then undergoes a phase inversion into an oil-in-water emulsion by passage through a jet disperser under increased pressure (1.0 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 12 sec |
| Solids content: | 50.0 wt. % |
| Average particle size (laser correlation spectroscopy): | 0.32 μm |
| Glass transition temperature: | 32.5° C. |

Dispersion I.7):

364.58 g of the polyacrylate polyol A 2, 32.73 g of the blocked polyisocyanate B 6, and 314.37 g of the blocked polyisocyanate B 8 are dissolved in 504.12 g MEK, and 3.35 g of the neutralizing agent dimethylethanolamine are added. 16.20 g Emulsifier WN (emulsifying auxiliary, Bayer AG) and 7.30 g Synperonic PE/F 127 are then added and a homogeneous mixture of the components is prepared by stirring.

A water-in-oil emulsion is prepared from 1,008.46 g of the solution of polyol, polyisocyanate, neutralizing agent and additives in MEK by intensive mixing with 500.00 g water by means of a dissolver, and then undergoes a phase inversion into an oil-in-water emulsion by passage through a jet disperser under increased pressure (10 bar) according to EP 0101007. The MEK is distilled off in vacuo. The emulsion is then filtered through a filter of mesh width 10 μm. A polymer dispersion with the following characteristic data results:

| | |
|---|---|
| Flow time (ISO 4 cup, 23° C.): | 13 sec |
| Solids content: | 50.0 wt. % |
| Average particle size (laser correlation spectroscopy): | 0.25 μm |
| Glass transition temperature: | 43.5° C. |

2. Use examples

The preparation of stoving filler compositions by means of base pastes such as is usually used in practice is described.

1. Base paste based on a self-crosslinking polyurethane dispersion (®Bayhydrol VP LS 2153, Bayer AG), comprising a polyhydroxy compound dispersed in water and a blocked polyisocyanate dispersed in water (not according to the invention).

For grinding for 30 minutes in a bead mill, the following components are weighed and predispersed for approx. 10 minutes by means of a dissolver:

670.9 parts by wt. of the 40% self-crosslinking PUR dispersion Bayhydrol VP LS 2153; 6.5 parts by wt. dimethylethanolamine, 10% in dist. water; 6.0 parts by wt. of a commercially available anti-cratering agent, 6.0 parts by wt. of a commercially available wetting agent; 4.0 parts by wt. of a conventional anti-sedimentation agent in the lacquer industry; 118.5 parts by wt. titanium dioxide; 1.3 parts by wt. iron oxide black; 119.2 parts by wt. micronized barite; 29.1 parts by wt. carbonate-free talc and 38.5 parts by wt. distilled water. This results in a paste with a solids content (binder:pigment/fillers =1:1) of approx. 53.6 wt. %.

2. Base paste based on the self-crosslinking dispersion 1.5) essential to the invention.

The following components are weighed, predispersed for approx. 10 minutes by means of a dissolver and then ground for 30 minutes in a bead mill: 692.5 parts by wt. of the 43.1% self-crosslinking dispersion 1.5); 3.0 parts by wt. of a commercially available defoamer; 4.5 parts by wt. of a conventional anti-sedimentation agent in the lacquer industry; 132.5 parts by wt. titanium dioxide; 1.4 parts by wt. iron oxide black; 133.5 parts by wt. micronized barite and 32.6 parts by wt. carbonate-free talc. This results in a paste with a solids content (binder:pigment/fillers =1: 1) of approx. 59.7 wt. %.

3. Base paste based on the self-crosslinking dispersion 1.4) essential to the 5 invention.

The following components are weighed, predispersed for approx. 10 minutes by means of a dissolver and then ground for 30 minutes in a bead mill: 680.4 parts by wt. of a 45.6% self-crosslinking dispersion 1.4); 3.1 parts by wt. of a commercially available defoamer; 4.6 parts by wt. of a conventional anti-sedimentation agent in the lacquer industry; 137.7 parts by wt. titanium dioxide; 1.5 parts by wt. iron oxide black; 138.8 parts by wt. micronized barite and 33.9 parts by wt. carbonate-free talc. This results in a paste with a solids content (binder:pigment/fillers =1:1) of approx. 62.4 wt. %.

Preparation of aqueous filler compositions based on base pastes 1 to 3.

The pastes are mixed homogeneously according to the ratios stated in the following table by dispersing for 10 minutes by means of a dissolver and, where appropriate, brought to a processing viscosity of ≦35 s (ISO cup 5 mm, ISO 2431) with water. The compositions and characteristic data of the aqueous filler compositions obtained are shown in the following table 2.

TABLE 2
Composition of aqueous filler compositions

| Filler | | | | | |
|---|---|---|---|---|---|
| composition | | | | | |
| example | 1¹⁾ | 2¹⁾ | 3¹⁾ | 4²⁾ | 5²⁾ |
| Paste 1, | 92.2 | | | 52.7 | 53.8 |
| 53.6% SC* | pt. by wt. | | | pt. by wt. | pt. by wt. |
| Paste 2, | | 100 | | 47.3 | |
| 59.7% SC* | | pt. by wt. | | pt. by wt. | |
| Paste 3, | | | 100 | | 46.2 |
| 62.4% SC* | | | pt. by wt. | | pt. by wt. |
| Dist. water | 9.8 | — | — | — | — |
| | pt. by wt. | | | | |
| | 100 | 100 | 100 | 100 | 100 |
| | pt. by wt. | pt. by wt. | pt. by wt. | pt. by wt. | pt. by wt. |
| Solids | 48.3% | 59.7% | 62.4% | 56.4% | 57.7% |
| content | | | | | |
| Flow time, | 34 s | 11 s | 35 s | 15 s | 21 s |
| 23° C. | | | | | |
| ISO cup | | | | | |
| 5 mm | | | | | |
| ISO 2431 | | | | | |
| Flow time, | 19 s | 11 s | 32 s | 15 s | 21 s |
| 23° C. | | | | | |
| after 14 d at | | | | | |
| 40° C. | | | | | |

*SC = solids content
¹⁾not according to the invention
²⁾according to the invention

The solids contents of filler compositions 4 and 5 according to the invention are significantly higher and their viscosity stability after storage at 40° C. is better than in the case of the high-quality comparison filler composition 1. Filler compositions 2 and 3, which are not according to the invention, based on the pastes of the components I) essential to the invention indeed have the highest solids contents of the examples, but the other properties of the filler compositions are not adequate, as is demonstrated below.

The aqueous filler compositions 1 to 5 were applied by spraying with a commercially available flow cup gun with an air pressure of 5 bar at approx. 65% rel. humidity (23° C.) on to zinc-phosphated steel sheets coated with a cathodically deposited electrodip primer (approx. 20 μm).

Curing of the filler compositions was carried out, after evaporation in air at 23° C. for 10 minutes, in a circulating air oven initially at 70° C. for 10 min and then at 165° C. for 20 min. The dry film thickness was approx. 35 μm.

The properties of the filler compositions are shown in the following table 3.

TABLE 3
Properties of the filler compositions

| Filler composition | | | | | |
|---|---|---|---|---|---|
| example | 1 | 2 | 3 | 4 | 5 |
| Erichsen | 9.2 mm | 2.7 mm | 5.1 mm | 8.4 mm | 8.6 mm |
| indentation | | | | | |
| DIN ISO 1520 | | | | | |
| Pendulum hardness | 70 s | 174 s | 163 s | 158 s | 149 s |
| DIN 53157 | | | | | |
| Gloss 60° C. | 68% | 33% | 44% | 65% | 70% |
| (Gardner method) | | | | | |

Filler compositions 4 and 5 according to the invention have a very high hardness and an elasticity which is very good for this hardness, compared with the commercially available filler composition 1. The gloss values of the filler compositions are at a similar level. Filler compositions 2 and 3 have a somewhat higher hardness than filler compositions 4 and 5 according to the invention, but a poorer elasticity and a lower gloss.

A commercially available car top lacquer based on alkyd/melamine resin was applied to the filler composition layers by means of an air-atomizing spray gun with a dry film thickness of approx. 30 μm and was cured at 130° C. for 30 min.

The most important test results which are decisive for use of the filler compositions are summarized in the following table. The resistance values, which are not stated, such as e.g. resistance to solvents, water and salt spray, correspond entirely to the requirements in practice.

Test Methods Used

Top lacquer status: Measurement of the waviness by means of a Wave Scan measuring apparatus from Byk

Resistance to flying stones: The test apparatuses used were

a) Flying stone test apparatus according to VDA (Erichsen, model 508) with 500 g steel shot (angular, 4-5 mm) fired in each case twice with an air pressure of 1.5 bar at 23° C. Comparisons were made in respect of penetrations down to the sheet metal (0 to 10, 0=no penetrations, 10=very many penetrations).

b) Individual impact test apparatus ESP-10 according to BMW standard DBP no. 34.31.390 (Byk), the chips of the filler composition from the sheet metal are measured in mm.

TABLE 4
Top lacquer status, measurement by means of the Wave Scan (Byk)
(corrected values stated)

| Filler composition example | 1 | 2 | 3 | 4 | 5 |
|---|---|---|---|---|---|
| Short-waviness | 7.3 | 6.0 | 5.6 | 5.7 | 4.5 |
| Long-waviness | 29.4 | 21.7 | 22.6 | 20.4 | 19.2 |

The lower the numerical values both for the short- and for the long-waviness, the better the top lacquer status. Filler compositions 4 to 5 according to the invention accordingly lead to a better top lacquer status than comparison filler compositions 1 to 3.

TABLE 5
Flying stones test
500 g steel shot twice, 1.5 bar (characteristic rating 1-10)

| Filler composition | | | | | |
|---|---|---|---|---|---|
| example | 1 | 2 | 3 | 4 | 5 |
| VDA multi-impact: | 1-2 | 2 | 2 | 1-2 | 1-2 |
| Characteristic rating for | | | | | |
| penetrations | | | | | |
| BMW individual impact | <1 mm | 2.5 mm | 2.5 mm | <1 mm | <1 mm |
| at −20° C. | | | | | |

Filler compositions 4 to 5 according to the invention are at the same high level as the high-quality comparison filler composition 1, although the filler compositions according to the invention have a considerably higher hardness. This result is surprising and is therefore not foreseeable. Filler compositions 2 and 3 have a poorer resistance to flying stones.

Summary and Discussion of the Results

Filler compositions 4 and 5 according to the invention are distinguished by a very high solids content and a very high hardness. Only a low elasticity associated with a lack of resistance to flying stones and a poor top lacquer status were therefore to be expected. However, the test results clearly show that the filler compositions according to the invention, in contrast to the prior art to date, have both good elasticity values and very good resistances to flying stones and top lacquer status, and are therefore superior to a high-quality commercially available polyurethane filler composition. They have a hitherto unknown quality level in respect of the overall spectrum of properties.

1. Binder mixture for aqueous stoving lacquers, comprising:
I) specific binders dispersed in water,
II) water-soluble or -dispersible polyhydroxy compounds,
III) water-soluble or -dispersible blocked polyisocyanates and/or amino resins and
IV) optionally further water-soluble or -dispersible substances,
characterized in that component I) comprises:
A) at least one polyol component based on polyacrylate polyols and/or polyester-polyacrylate polyols with a hydroxyl group content of 1.0 to 8.0 wt. %, a carboxyl group content of 0 to 3.0 wt. %, a weight-average molecular weight of 2,000 to 50,000 and a glass transition temperature of ≧10° C.,
B) at least one polyisocyanate component with blocked isocyanate groups based on (cyclo)aliphatic polyisocyanates with a content of blocked isocyanate groups of 5.0 to 25.0 wt. %,
C) optionally further polyfunctional polyols,
D) optionally further crosslinking substances,
E) optionally external emulsifiers and
F) optionally conventional additives,
with the proviso that component I) has been prepared either by a direct dispersing process or by the phase inversion process by means of a dispersing device with a high dispersing output per unit volume and has an average particle size of the dispersions particles of 0.05 to 10 μm, preferably 0.1 to 5 μm, in particular at a particle diameter of 0.15 to 2.5 μm, and particularly preferably 0.2 to 1.5 μm.

2. Binder mixture according to claim 1, characterized in that the polyol component A) of component 1) comprises:
a) 0 to 100 parts by wt. of a polyester component comprising at least one polyester polyol with a hydroxyl number of 20 to 240 mg KOH/g at an acid number of <20 mg KOH/g and a glass transition temperature of −40 to +100° C.,
b) 0 to 15 parts by wt. of an olefinically unsaturated ester component comprising at least one maleic acid di(cyclo)alkyl ester having 1 to 12 carbon atoms in the (cyclo)alkyl radical,
c) 0 to 70 parts by wt. of (cyclo)alkyl esters of acrylic and/or methacrylic acid having 1 to 18 carbon atoms in the (cyclo)alkyl radical,
d) 0 to 70 parts by wt. of aromatic, olefinically unsaturated monomers,
e) 5 to 60 parts by wt. of hydroxyalkyl esters of acrylic and/or methacrylic acid having 2 to 4 carbon atoms in the hydroxyalkyl radical and/or reaction products thereof, with a maximum molecular weight of 500, with ε-caprolactone and addition products of acrylic and/or methacrylic acid and monoepoxide compounds, which can also be produced in situ during the free-radical polymerization,
f) 0 to 10 parts by wt. of olefinically unsaturated carboxylic acids and
g) 0 to 30 parts by wt. of further copolymerizable, olefinically unsaturated compounds,
the sum of the parts by wt. of components a) to g) giving 100.

3. Binder mixture according to claims 1 and 2, characterized in that the polyol component A) of component 1) comprises:
a) 0 to 60 parts by wt. of a polyester component comprising at least one polyester polyol with a hydroxyl number of 30 to 200 mg KOH/g at an acid number of <15 mg KOH/g and a glass transition temperature of −30 to +80° C.,
b) 0 to 12.5 parts by wt. of an olefinically unsaturated ester component comprising at least one maleic acid di(cyclo)alkyl ester having 1 to 6 carbon atoms in the (cyclo)alkyl radical,
c) 5 to 65 parts by wt. of (cyclo)alkyl esters of acrylic and/or methacrylic acid having 1 to 15 carbons atoms in the (cyclo)alkyl radical,
d) 0 to 65 parts by wt. styrene, α-methylstyrene and/or vinyltoluene,
e) 5 to 55 parts by wt. of hydroxyalkyl esters of acrylic and/or methacrylic acid having 2 to 4 carbon atoms in the hydroxyalkyl radical and/or reaction products thereof, with a maximum molecular weight of 500, with ε-caprolactone and addition products of acrylic and/or methacrylic acid and monoepoxide compounds, which can also be produced in situ during the free-radical polymerization,
f) 0 to 7.5 parts by wt acrylic acid, methacrylic acid, maleic acid, fumaric acid and/or maleic and/or fumaric acid half-esters having 1 to 8 carbon atoms in the alcohol radical and
g) 0 to 25 parts by wt. of further copolymerizable, olefinically unsaturated compounds,
the sum of the parts by wt. of components a) to g) giving 100.

4. Binder mixture according to claims 1 to 3, characterized in that the polyol component A) of component I) comprises:
a) 0 to 50 parts by wt. of a polyester component comprising at least one polyester polyol with a hydroxyl number of 40 to 160 mg KOH/g at an acid number of <12 mg KOH/g and a glass transition temperature of-30 to +70° C.,
b) 0 to 10 parts by wt. dimethyl maleate, diethyl maleate, dibutyl maleate or mixtures of these monomers,
c) 5 to 60 parts by wt. of (cyclo)alkyl esters of acrylic and/or methacrylic acid having 1 to 12 carbon atoms in the (cyclo)alkyl radical,
d) 5 to 50 parts by wt. styrene,
e) 10 to 50 parts by wt. hydroxyethyl acrylate, hydroxyethyl methacrylate, hydroxypropyl acrylate, hydroxypropyl methacrylate, hydroxybutyl acrylate and/or hydroxybutyl methacrylate,
f) 0.5 to 5 parts by wt. acrylic acid and/or methacrylic acid and
g) 0 to 20 parts by wt. of further copolymerizable, olefinically unsaturated compounds,
the sum of components a) to g) giving 100.

5. Binder mixture according to claim 1, characterized in that component II) comprises: polyhydroxypolyesters, polyhydroxypolyethers, polyhydroxypolyurethanes, polyhydroxycarbonates, urethane-modified polyester polyols, urethane-modified polyether polyols, urethane-modified polycarbonate polyols, polymers containing hydroxyl groups, polyester-polyacrylate polyols, polyether-polyacrylate polyols, polyurethane-polyacrylate polyols, polyester-polyurethanes, polyether-polyurethanes, polycarbonate-polyurethanes, polyether-polyesters or mixtures thereof.

6. Binder mixture according to claim 1, characterized in that component III) comprises: water-soluble or -dispersible blocked polyisocyanates.

7. Binder mixture according to claim 1, characterized in that component III) comprises: water-soluble or -dispersible amino resins.

8. Use of the binder mixtures according to claims 1 to 7 for the preparation of aqueous stoving lacquers which optionally comprise the conventional auxiliary substances and additives of coating technology.

9. Aqueous stoving lacquer, the binder of which comprises a combination of
I) specific binders dispersed in water,
II) water-soluble or -dispersible polyhydroxy compounds,
III) water-soluble or -dispersible blocked polyisocyanates and/or amino resins and
IV) optionally further water-soluble or -dispersible substances,
characterized in that component I) substantially comprises:
A) a polyol component based on polyacrylate polyols and/or polyester-polyacrylate polyols with a hydroxyl group content of 1.0 to 8.0 wt. %, a carboxyl group content of 0 to 3.0 wt. %, a weight-average molecular weight of 2,000 to 50,000 and a glass transition temperature of ≧10° C.,
B) a polyisocyanate component with blocked isocyanate groups based on (cyclo)aliphatic polyisocyanates with a content of blocked isocyanate groups of 5.0 to 25.0 wt. %,
C) optionally further polyfunctional polyols,
D) optionally further crosslinking substances,
E) optionally external emulsifiers and
F) optionally conventional additives,
and in that component I) has been prepared either by a direct dispersing process or by the phase inversion process by means of a dispersing device with a high dispersing output per unit volume, and then has an average particle size of the dispersion particles of 0.05 to 10 μm.

10. Use of the aqueous stoving lacquer according to claim 9 for the preparation of filler compositions for car body components.
